(19) United States
(12) Patent Application Publication
(10) Pub. No.: US 2024/0262338 A1
(43) Pub. Date: Aug. 8, 2024

(54) VEHICLE CONTROL DEVICE, CONTROL METHOD OF VEHICLE, AND RECORDING MEDIUM

(71) Applicant: HONDA MOTOR CO., LTD., Tokyo (JP)

(72) Inventors: Hiroki Yoshikawa, Tokyo (JP); Naoto Yamamoto, Tokyo (JP); Takayuki Inomata, Tokyo (JP)

(21) Appl. No.: 18/425,554

(22) Filed: Jan. 29, 2024

(30) Foreign Application Priority Data
Feb. 2, 2023 (JP) 2023-014419

(51) Int. Cl. B60W 10/20; B60W 10/04; B60W 30/182; B60W 40/08; B60W 50/04

(52) U.S. Cl. CPC B60W 10/20; B60W 10/04; B60W 30/182; B60W 2040/0809; B60W 2050/046; B60W 2420/00; B60W 2540/01; B60W 2756/10

(57) ABSTRACT

A vehicle control device includes a vehicle activation control unit. The vehicle activation control unit executes unlock processing for operating a steering lock mechanism by a steering lock control unit to attain a steering unlock state when an operation to start travel of a vehicle is recognized in a non-travelable mode, transitions the vehicle to a travelable mode where the vehicle is allowed to travel when a steering unlock recognition unit recognizes that a steering unlock state is attained by execution of the unlock processing, and prohibits transition to the travelable mode and maintains the vehicle in the non-travelable mode when the unlock processing is executed but the steering unlock recognition unit does not recognize that the steering unlock state is attained.

### INCORPORATION BY REFERENCE

The present application claims priority under 35 U.S.C. § 119 to Japanese Patent Application No. 2023-014419 filed on Feb. 2, 2023. The content of the application is incorporated herein by reference in its entirety.

### BACKGROUND OF THE INVENTION

### Field of the Invention

The present invention relates to a vehicle control device, a control method of a vehicle, and a recording medium.

### Description of the Related Art

Vehicles conventionally include an anti-theft steering lock mechanism, and configurations have been proposed to cope with false detection of an unlock state in which a locking member of the steering lock mechanism is at an unlock position.

For example, Japanese Patent Laid-Open No. 2013-248899 and Japanese Patent Laid-Open No. 2012-025269 disclose a configuration including a first magnetism detecting element that is switched from an ON state to an OFF state and a second magnetism detecting element that is switched from the OFF state to the ON state when the locking member shifts to the unlock position, so as to prevent false detection caused by a single-pole (N-pole or S-pole) electromagnetic field generated from the outside.

When a user riding in a vehicle performs activation operation of a vehicle while the steering of the vehicle is locked by a steering lock mechanism, the user needs to unlock the steering to enable driving of the vehicle. However, inventors of the present invention found that when the steering lock mechanism is operated to unlock the steering, the steering may insufficiently be unlocked in some cases. In the case where the steering is insufficiently unlocked, it is necessary to prevent the vehicle from starting to travel.

Accordingly, it is a task of the present invention to prevent the vehicle from starting to travel while the steering is insufficiently unlocked.

An object of the present invention is to enhance safety by accomplishing the above task. Accordingly, the present invention contributes to the development of sustainable transportation systems by further enhancing the traffic safety.

### SUMMARY OF THE INVENTION

In order to accomplish the above object, a first aspect relates to a vehicle control device mounted on a vehicle having a steering lock mechanism, the vehicle control device including: a steering lock control unit that operates the steering lock mechanism to switch between a steering lock state where a steering included in the vehicle is not operable and a steering unlock state where the steering is operable; a steering unlock recognition unit that recognizes that the steering unlock state is attained; a travel start operation recognition unit that recognizes an operation to start travel of the vehicle in the vehicle; and a vehicle activation control unit that executes unlock processing for operating the steering lock mechanism by the steering lock control unit to attain the steering unlock state when the travel start operation recognition unit recognizes the operation to start travel of the vehicle in the vehicle in a non-travelable mode where the vehicle is not allowed to travel, transitions the vehicle to a travelable mode where the vehicle is allowed to travel when the steering unlock recognition unit recognizes that the steering unlock state is attained by execution of the unlock processing, and prohibits transition to the travelable mode and maintains the vehicle in the non-travelable mode when the unlock processing is executed but the steering unlock recognition unit does not recognize that the steering unlock state is attained.

The above vehicle control device may include a remote operation acceptance unit that accepts remote operation of the vehicle via communication with a communication terminal, in which the vehicle activation control unit may be configured to execute remote activation processing for maintaining the non-travelable mode and putting a driving source included in the vehicle in an operating state when the remote operation acceptance unit accepts the activation operation of the vehicle in the non-travelable mode.

In the above vehicle control device, the vehicle activation control unit may be configured to give a notification to urge an operation to start the travel of the vehicle by a notification unit included in the vehicle when the non-travelable mode is maintained and the driving source is in the operating state by the remote activation processing.

The above vehicle control device may include a travel end operation recognition unit that recognizes an operation to end the travel of the vehicle in the vehicle, in which the vehicle activation control unit may be configured to maintain the vehicle in the travelable mode until the travel end operation recognition unit recognizes the operation to end the travel of the vehicle after the non-travelable mode is transitioned to the travelable mode.

In the above vehicle control device, the vehicle activation control unit may be configured to give a notification to urge an operation to unlock the steering by a notification unit included in the vehicle when the unlock processing is executed but the steering unlock recognition unit does not recognize that the steering unlock state is attained.

The above vehicle control device may include a user authentication unit that authenticates whether or not a registered specific user rides in the vehicle, in which the vehicle activation control unit may be configured to execute processing to unlock the steering when the unlock processing is executed but the steering unlock recognition unit does not recognize that the steering unlock state is attained, and the user authentication unit authenticates that the specific user rides in the vehicle.

In order to accomplish the above object, a second aspect relates to a control method of a vehicle having a steering lock mechanism executed by a computer, the control method of the vehicle including: a steering lock control step of operating the steering lock mechanism to switch between a steering lock state where a steering included in the vehicle is not operable and a steering unlock state where the steering is operable; a steering unlock recognition step of recognizing that the steering unlock state is attained; a travel start operation recognition step of recognizing an operation to start travel of the vehicle in the vehicle; and a vehicle activation control step including executing unlock processing for operating the steering lock mechanism in the steering lock control step to attain the steering unlock state when the operation to start travel of the vehicle in the vehicle is recognized in the travel start operation recognition step in a non-travelable mode where the vehicle is not allowed to travel, transitioning the vehicle to a travelable mode where the vehicle is allowed to travel when it is recognized in the steering unlock recognition step that the steering unlock state is attained by execution of the unlock processing, and prohibiting transition to the travelable mode and maintaining the vehicle in the non-travelable mode when the unlock processing is executed but it is not recognized in the steering unlock recognition step that the steering unlock state is attained.

In order to accomplish the above object, a third aspect relates to a non-transitory recording medium storing a program that allows a computer mounted on a vehicle having a steering lock mechanism to function as: a steering lock control unit that operates the steering lock mechanism to switch between a steering lock state where a steering included in the vehicle is not operable and a steering unlock state where the steering is operable; a steering unlock recognition unit that recognizes that the steering unlock state is attained; a travel start operation recognition unit that recognizes an operation to start travel of the vehicle in the vehicle; and a vehicle activation control unit that executes unlock processing for operating the steering lock mechanism by the steering lock control unit to attain the steering unlock state when the travel start operation recognition unit recognizes the operation to start travel of the vehicle in the vehicle in a non-travelable mode where the vehicle is not allowed to travel, transitions the vehicle to a travelable mode where the vehicle is allowed to travel when the steering unlock recognition unit recognizes that the steering unlock state is attained by execution of the unlock processing, and prohibits transition to the travelable mode and maintains the vehicle in the non-travelable mode when the unlock processing is executed but the steering unlock recognition unit does not recognize that the steering unlock state is attained.

The above vehicle control device can prevent the vehicle from staring to travel while the steering is insufficiently unlocked.

### BRIEF DESCRIPTION OF THE DRAWINGS

FIG. 1 is a configuration diagram of a vehicle control device and a vehicle mounted with the vehicle control device;

FIG. 2 is a first flowchart of processing corresponding to vehicle activation;

FIG. 3 is a second flowchart of the processing corresponding to vehicle activation;

FIG. 4 is a timing chart when the steering unlock processing is normally completed; and

FIG. 5 is a timing chart when the steering unlock processing is not normally completed.

### DETAILED DESCRIPTION OF THE PREFERRED EMBODIMENTS

### 1. Configuration of Vehicle Control Device

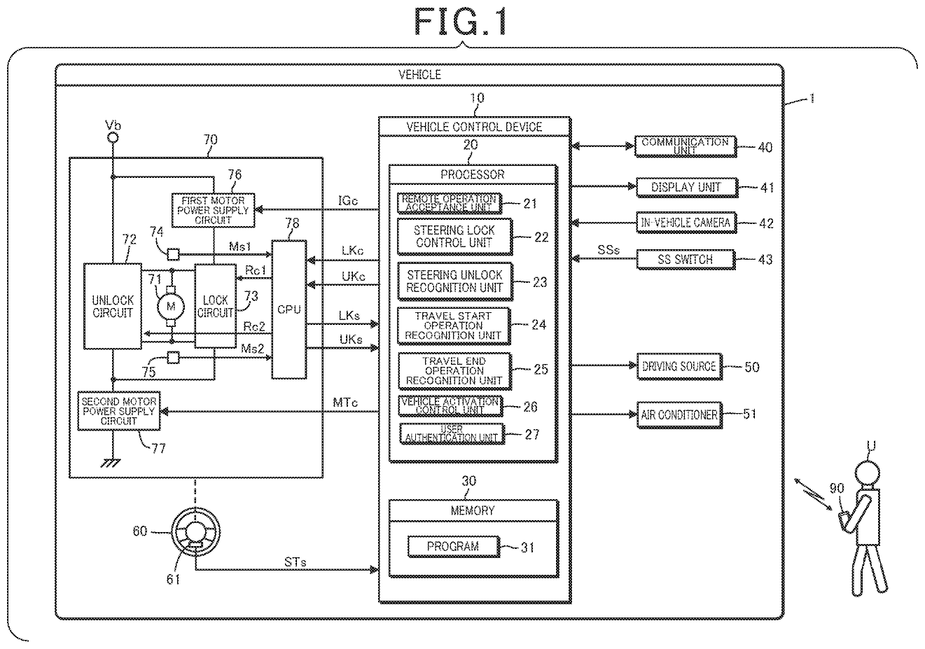

The configuration of a vehicle control device 10 of the present embodiment will be described with reference to FIG. 1. The vehicle control device 10 is mounted on a vehicle 1 to control the operation of the vehicle 1. The vehicle control device 10 is connected to a communication unit 40, a display unit 41, an in-vehicle camera 42, an SS switch (start stop switch) 43, a driving source 50, an air conditioner 51, an electrical steering lock (ESL) 70, and a steering sensor 61 included in the vehicle.

The vehicle control device 10 uses the communication unit 40 to wirelessly communicate with a communication terminal 90 used by a user U of the vehicle 1. The wireless communication is executed based on, for example, Bluetooth (registered trademark) communication standards. The communication terminal 90 may be a smartphone, a mobile phone, or a tablet terminal with a remote operation application (an application program) for the vehicle 1 installed therein, or a mobile key (FOB key) and the like having the function of remote operation of the vehicle 1.

The display unit 41 is a touch panel, for example. The in-vehicle camera 42 takes images of the interior of the vehicle 1. The SS switch 43 is an operation switch to instruct activation (IG (ignition) on, power on) and stop (IG off, power off) of the vehicle 1. The driving source 50 is an engine when the vehicle 1 is an engine vehicle, and is a battery when the vehicle 1 is an electric vehicle. When the vehicle 1 is a hybrid vehicle, the driving source 50 includes an engine and a battery. The air conditioner 51 provides air conditioning for the interior of the vehicle 1. The steering sensor 61 detects an operation amount of the steering 60.

The vehicle control device 10 receives input of an image taken by the in-vehicle camera 42, an operation signal SSs of the SS switch 43, and a detection signal of the steering sensor 61. Based on control signals output from the vehicle control device 10, the operation of the driving source 50 and the air conditioner 51 is controlled.

The ESL unit 70 has a steering lock mechanism that displaces a locking member (not shown) by an electric motor 71 to attain a steering lock state where the steering 60 is not operable. The ESL unit 70 includes a first motor power supply circuit 76, a second motor power supply circuit 77, an unlock circuit 72, a lock circuit 73, and a CPU 78 for operating the electric motor 71.

In response to input of a lock instruction signal Rc1 from the CPU 78, the lock circuit 73 uses an unillustrated relay circuit to set the direction of energizing the electric motor 71 to the direction in which the locking member is displaced to the position where the steering 60 is locked by the operation of the electric motor 71. In response to input of an unlock instruction signal Rc2 from the CPU 78, the unlock circuit 72 uses an unillustrated relay circuit to set the direction of energizing the electric motor 71 to the direction in which the locking member is displaced to the position where the steering 60 is unlocked by the operation of the electric motor 71.

The first motor power supply circuit 76 changes the connection between the motor power source Vb and the lock circuit 73 to a conduction state and a cut-off state depending on the presence or absence of input of an IG control signal IGc from the vehicle control device 10. When the IG control signal IGc is input, the first motor power supply circuit 76 puts the connection between the motor power source Vb and the lock circuit 73 in the cut-off state. This prohibits the steering lock state by the lock circuit 73. Meanwhile, when the IG control signal IGc is not input, the first motor power supply circuit 76 puts the connection between the motor power source Vb and the lock circuit 73 in the conduction state and allows of the steering lock state.

The second motor power supply circuit 77 changes the connection between the unlock circuit 72 and a ground (a negative potential part of the motor power source Vb) and between the lock circuit 73 and the ground to a conduction state and a cut-off state depending on the presence or absence of input of a motor control signal MTc from the vehicle control device 10. When the motor control signal MTc is input, the second motor power supply circuit 77 puts the connection between the unlock circuit 72 and the ground and between the lock circuit 73 and the ground to the conduction state to enable the electric motor 71 to operate. Meanwhile, when the motor control signal MTc is not input, the second motor power supply circuit 77 puts the connection between the unlock circuit 72 and the ground and between the lock circuit 73 and the ground to the cut-off state to disable the electric motor 71 to operate.

When the lock request signal LKc is input from the vehicle control device 10, the CPU 78 inputs the lock instruction signal Rc1 to the lock circuit 73 to operate the electric motor 71 and thereby attains the steering lock state. When the unlock request signal UKc is input from the vehicle control device 10, the CPU 78 inputs an unlock instruction signal Rc2 to the unlock circuit 72 to operate the electric motor 71 and thereby attains the steering unlock state.

In addition, the ESL unit 70 includes an unlock sensor 74 that outputs a detection signal Ms1 to the CPU 78 by detecting that the lock member is displaced to an unlock position and the steering unlock state is attained. The ESL unit 70 also includes a lock sensor 75 that outputs a detection signal Ms2 to the CPU 78 by detecting that the lock member is displaced to a lock position and the steering lock state is attained. When the detection signal Ms1 of the unlock sensor 74 is input, the CPU 78 inputs an unlock detection signal UKs to the vehicle control device 10, and when the detection signal Ms2 is input, the CPU 78 inputs a lock detection signal LKs to the vehicle control device 10.

Thus, the ESL unit 70 basically switches the steering 60 to the steering lock state or the steering unlock state. However, when the electric motor 71 displaces the locking member to the unlock position, the displacement of the locking member may be disturbed by such reasons as interference between the locking member and other members, and the locking member may be stopped unstably in the middle of the lock position and the unlock position. In this case, both the detection signal Ms1 of the unlock sensor 74 and the detection signal Ms2 of the lock sensor 75 are not output (not in a stable state).

The vehicle control device 10 is a control unit including a processor 20, a memory 30, and an interface circuit not illustrated. The processor 20 corresponds to the computer in the present disclosure. The memory 30 stores a program 31 for control of the vehicle control device 10. The program 31 may be transmitted from an external server to the vehicle 1 and be stored in the memory 30 by the vehicle control device 10. Alternatively, the vehicle control device 10 may read the program 31 stored in a non-transitory recording medium (such as magnetic disks, magnetic tapes, optical disks, and flash memories) and store the program 31 in the memory 30.

The processor 20 reads and executes the program 31 to function as a remote operation acceptance unit 21, a steering lock control unit 22, a steering unlock recognition unit 23, a travel start operation recognition unit 24, a travel end operation recognition unit 25, a vehicle activation control unit 26, and a user authentication unit 27. The processing executed by the steering lock control unit 22 corresponds to the steering control step in the control method of a vehicle of the present disclosure, and the processing executed by the steering unlock recognition unit 23 corresponds to the steering unlock recognition step in the control method of a vehicle of the present disclosure. The processing executed by the travel start operation recognition unit 24 corresponds to the travel start operation recognition step in the control method of a vehicle of the present disclosure, and the processing executed by the vehicle activation control unit 26 corresponds to the vehicle activation control step in the control method of a vehicle of the present disclosure.

The remote operation acceptance unit 21 accepts the remote operation for the vehicle 1 by the user U by receiving, with the communication unit 40, operation instruction information for the vehicle 1 transmitted from the communication terminal 90. The user U can give an instruction relating to activation of the vehicle 1, operation of the air conditioner 51, or the like, by remote operation.

The steering lock control unit 22 controls output of the IG control signal IGc, the motor control signal MTc, a lock request signal LKc, and an unlock request signal UKc to the ESL unit 70 so as to switch between the steering lock state and the steering unlock state. The steering unlock recognition unit 23 recognizes the steering unlock state based on the unlock detection signal UKs output from the ESL unit 70 and recognizes the steering lock state based on the lock detection signal LKs from the ESL unit 70.

The travel start operation recognition unit 24 recognizes travel start operation with the SS switch 43 based on the operation signal of the SS switch 43, and the travel end operation recognition unit 25 recognizes travel end operation with the SS switch 43 based on the operation signal SSs of the SS switch 43. The vehicle activation control unit 26 executes the processing relating to activation of the vehicle 1 in response to an activation instruction of the vehicle 1 by the remote operation acceptance unit 21 and the travel start operation with the SS switch 43 recognized by the travel start operation recognition unit 24.

The user authentication unit 27 collates identification information transmitted from the communication terminal 90 with registered information on the user of the vehicle 1 stored in the memory 30 to authenticate that the user U riding in the vehicle 1 is a specific user registered in association with the vehicle 1. Alternatively, a face image of the user U riding in the vehicle 1, which is taken by the in-vehicle camera 42, is collated with the face image of the specific user stored in the memory 30 to authenticate that the user U is the specific user.

### 2. Processing Corresponding to Vehicle Activation

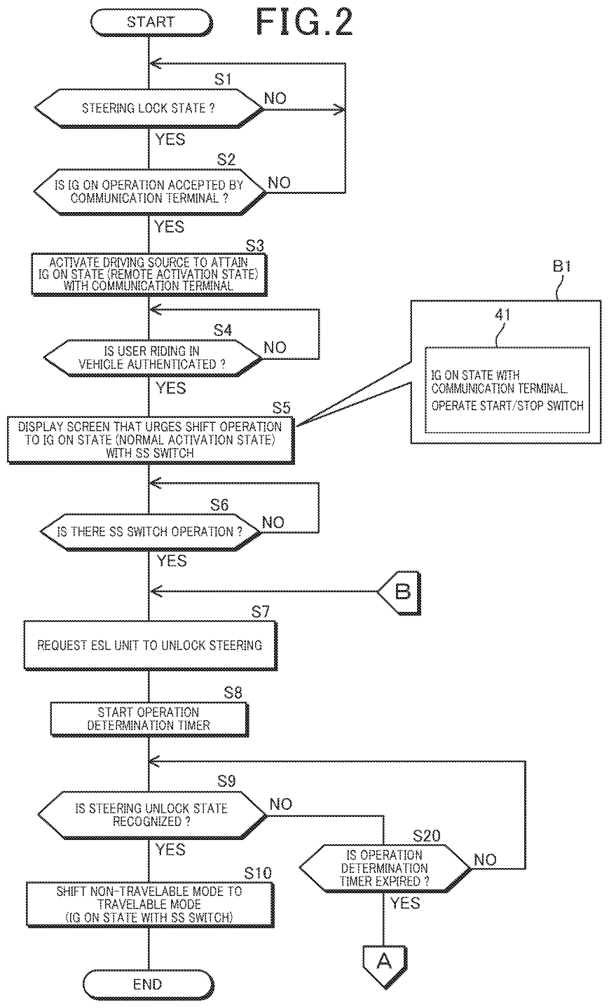

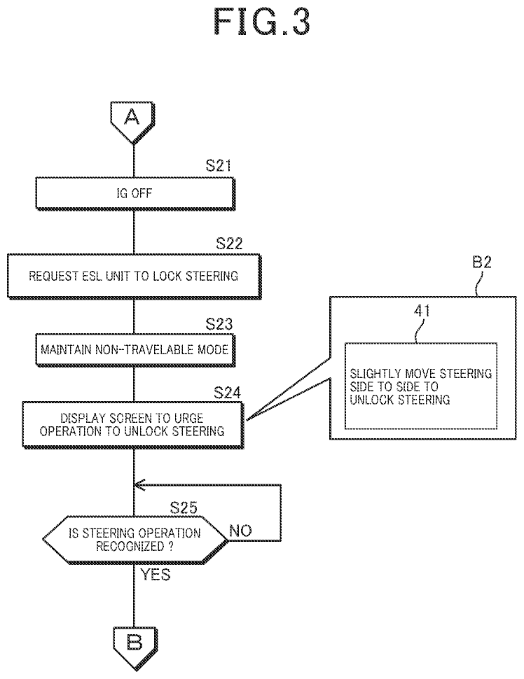

According to the flowcharts shown in FIGS. 2 and 3, processing corresponding to vehicle activation executed by the vehicle control device 10 will be described.

With a loop of steps S1 and S2 in FIG. 2, the vehicle activation control unit 26 advances the processing to step S3 when the steering unlock recognition unit 23 recognizes that the steering lock state (the state in the non-travelable mode) is attained in step S1, and the remote operation acceptance unit 21 accepts activation operation of the vehicle 1 via the communication terminal 90.

In step S3, the vehicle activation control unit 26 activates the driving source 50 and puts the vehicle 1 in an IG on state (remote activation state) with the communication terminal 90. In the IG on state with the communication terminal 90, the vehicle activation control unit 26 turns on the power source of the vehicle 1 and activates the engine when the driving source 50 is the engine. In the IG on state with the communication terminal 90, the user U can instruct turning on and off the air conditioner 51, or the like, by operating the communication terminal 90.

In next step S4, the user authentication unit 27 determines whether or not the user U riding in the vehicle 1 is a specific user, and when the user U is authenticated as the specific user, the processing proceeds to step S5. In step S5, as shown in a balloon B1, the vehicle activation control unit 26 notifies the IG on state by the communication terminal 90 and displays on the display unit 41 a screen that urges shift to a normal IG on state by operating the SS switch 43.

In next step S6, when the travel start operation recognition unit 24 recognizes the operation (the travel start operation) of the SS switch 43, the vehicle activation control unit 26 advances the processing to step S7. In step S7, the vehicle activation control unit 26 outputs the unlock request signal UKc to the ESL unit 70 to request switching to the unlock state. In next step S8, the vehicle activation control unit 26 starts an operation determination timer.

With a loop of next steps S9 and S20, the vehicle activation control unit 26 determines in step S9 whether or not the steering unlock recognition unit 23 recognizes that the steering unlock status is attained before the operation determination timer expires in step S20. Then, when the steering unlock recognition unit 23 recognizes that the steering lock state is attained in step S9, the vehicle activation control unit 26 advances the processing to step S10.

In step S10, the vehicle activation control unit 26 transitions the vehicle 1 from the non-travelable mode to the travelable mode to enable the user U to perform driving operation. In the travelable mode, the vehicle activation control unit 26 outputs the IG control signal IGc to the ESL unit 70 to prohibit switching to the steering lock state. In addition, the vehicle activation control unit 26 ends the output of the IG control signal IGc to the ESL unit 70 when the travel of the vehicle 1 stops and the travel end operation recognition unit 25 recognizes the operation (the travel end instruction operation) of the SS switch 43. The vehicle activation control unit 26 then outputs the lock request signal LKc to the ESL unit 70 to attain the steering lock state, and transitions the vehicle 1 from the travelable mode to the non-travelable mode.

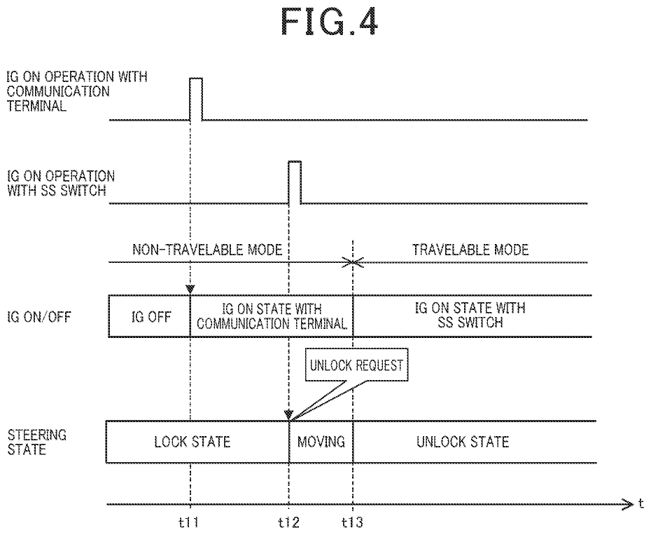

Here, FIG. 4 is a timing chart showing, with a time axis t, the timing of IG on operation with the communication terminal 90, IG on operation with the SS switch 43, transition between the IG on state and the IG off state, and transition between the lock state and the unlock state of the steering 60 by the ESL unit 70, in the situation where switching from the steering lock state to the steering unlock state is normally completed, and the vehicle 1 transitions from the non-travelable mode to the travelable mode.

When the remote operation acceptance unit 21 recognizes the IG on operation at t11 in FIG. 4, the vehicle activation control unit 26 switches the vehicle 1 from the IG off state to the IG on state with the communication terminal. Then, when the travel start operation recognition unit 24 recognizes the IG on operation with the SS switch 43 at t12, the vehicle activation control unit 26 outputs the unlock request signal UKc to the ESL unit 70.

The ESL unit 70, which has received input of the unlock request signal UKc, starts the displacement of the locking member from the locked position to the unlocked position (described as “moving” in FIG. 4) with the electric motor 71. At t13, the steering unlock recognition unit 23 recognizes that the locking member is displaced to the unlock position so that a steering unlock state is attained. As a result, the shift from the steering lock state to the steering unlock state is normally completed, and the vehicle 1 transitions from the non-travelable mode to the travelable mode.

Meanwhile, in the case where the steering unlock recognition unit 23 does not recognize that the unlock state is attained as the locking member is displaced to the unlock position when the operation determination timer expires, that is, before the set time of the operation determination timer elapses, the vehicle activation control unit 26 advances the processing to step S21 in FIG. 3.

In step S21, the vehicle activation control unit 26 puts the vehicle 1 in the IG off state. In next step S22, the vehicle activation control unit 26 outputs the lock request signal LKc to the ESL unit 70 to attain the steering lock state, and maintains the vehicle 1 in the non-travelable mode in following step S23. This prevents the vehicle 1 from starting to travel without recognizing that the steering unlock state is attained.

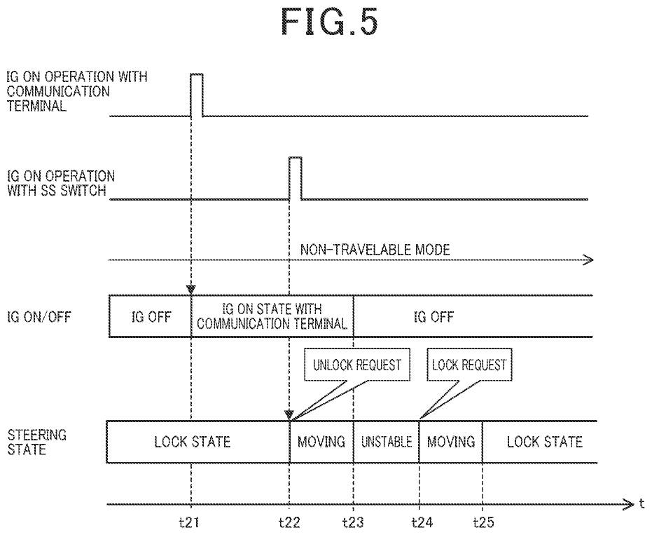

Here, FIG. 5 is a timing chart showing, with a time axis t, the timing of IG on operation with the communication terminal 90, IG on operation with the SS switch 43, transition between the IG on state and the IG off state, and transition between the lock state and the unlock state of the steering 60, in the situation where the steering lock state is maintained because the steering unlock state is not recognized.

When the remote operation acceptance unit 21 recognizes the IG on operation at t21 in FIG. 5, the vehicle activation control unit 26 switches the vehicle 1 from the IG off state to the IG on state with the communication terminal. Then, when the travel start operation recognition unit 24 recognizes the IG on operation with the SS switch 43 at t22, the vehicle activation control unit 26 outputs the unlock request signal UKc to the ESL unit 70.

The ESL unit 70, which has received input of the unlock request signal UKc, starts the displacement of the locking member from the lock position to the unlock position (described as “moving” in FIG. 5) with the electric motor 71. However, an unstable state continues as the steering unlock recognition unit 23 does not recognize that the locking member is displaced to the unlocked position. Therefore, the vehicle activation control unit 26 puts the vehicle 1 in the IG off state at t23, and inputs the lock request signal LKc to the ESL unit 70 at t24.

The ESL unit 70, which has received input of the unlock request signal UKc, starts the displacement of the locking member to the locked position (described as “moving” in FIG. 5) with the electric motor 71, and the steering unlock recognition unit 23 recognizes that the locking member is at the lock position at t25. As a result, the non-travelable mode where the steering 60 is not operable by the user U is attained, which prevents the vehicle 1 from starting to travel without recognizing the unlocking of the steering 60.

In step S24 in FIG. 3, the vehicle activation control unit 26 displays a screen on the display unit 41 to urge movement of the steering 60 from side to side, as shown in a balloon B2. In response to a notification, the user U is expected to move the steering 60 from side to side to eliminate the interference between the locking member and other members and to recover the state where displacement of the locking member to the unlock position is allowed.

In following step S25, when the operation of the steering 60 is recognized based on a detection signal STs of the steering sensor 61, the vehicle activation control unit 26 advances the processing to step S7 in FIG. 2 and executes the processing to unlock the steering 60 again.

### 3. Another Embodiment

In the above embodiment, the travel start operation recognition unit 24 recognizes the travel start operation by the user U based on the operation signal SSs of the SS switch 43. In another embodiment, the travel start operation may be recognized by recognizing, for example, the operation of the steering 60, the operation of unillustrated operation units, such as a shift lever, an accelerator pedal, and a brake pedal included in the vehicle 1, an instruction voice of the user U, or an instruction gesture of the user U.

In the above embodiment, when it is not possible to recognize that the steering 60 is put in the unlock state in the processing of steps S9 and S20 in FIG. 2, the vehicle activation control unit 26 puts the vehicle 1 in the IG off state in step S21 in FIG. 3, and then performs locking request to the ESL unit 70 in step S22. However, the processing to put the vehicle 1 in the IG off state in step S21 may be omitted.

In the above embodiment, when unlocking of the steering 60 is not recognized in the processing of steps S9 and S20 in FIG. 3, a notification is made to urge the user U to perform unlocking operation of the steering 60 in steps S23 and S24 in FIG. 4. In another embodiment, in step S4 of FIG. 2, the vehicle activation control unit 26 may execute the processing to unlock the steering 60 on the condition that the user U is authenticated as a specific user. As the processing to unlock the steering 60, an unlock request signal UKc may be input to the ESL unit 70 and the ESL unit 70 may execute the unlock processing again, for example.

Alternatively, the vehicle activation control unit 26 may be configured to automatically execute the processing to lock the steering 60 and the processing to unlock the steering 60 by the ESL unit 70 so as to retry unlocking of the steering 60. In addition, the vehicle activation control unit 26 may be configured to perform the processing to lock the steering 60 and the processing to unlock the steering 60 by the ESL unit 70 when the IG is turned off by the operation of the SS switch 43 and then the IG is turned on by the operation of the SS switch 43 again.

In the above embodiment, the case where the remote operation acceptance unit 21 accepts the IG on operation with the communication terminal 90 and the vehicle activation control unit 26 puts the vehicle 1 in the IG on state has been described. As another embodiment, even in the case where the user U rides in the vehicle 1 without performing the IG on operation with the communication terminal 90, and performs the IG on operation with the SS switch 43, executing the processing in step S7 and subsequent steps in FIG. 2 makes it possible to prevent the vehicle 1 from starting to travel in the situation where unlocking of the steering 60 is unrecognizable.

Note that FIG. 1 is a schematic view in which the configuration of the vehicle control device 10 is categorized and shown according to main processing contents for easy understanding of the present invention, and therefore, the configuration of the vehicle control device 10 may be configured according to other categories. The processing of each component member may be executed by a single hardware unit or may be executed by a plurality of hardware units. The processing by each component member shown in FIGS. 2 to 3 may be executed by a single program or may be executed by a plurality of programs.

### 4. Configurations Supported by Above Embodiment

The above embodiment is specific examples of the following configurations.

(Configuration 1) A vehicle control device mounted on a vehicle having a steering lock mechanism, the vehicle control device including: a steering lock control unit that operates the steering lock mechanism to switch between a steering lock state where a steering included in the vehicle is not operable and a steering unlock state where the steering is operable; a steering unlock recognition unit that recognizes that the steering unlock state is attained; a travel start operation recognition unit that recognizes an operation to start travel of the vehicle in the vehicle; and a vehicle activation control unit that executes unlock processing for operating the steering lock mechanism by the steering lock control unit to attain the steering unlock state when the travel start operation recognition unit recognizes the operation to start travel of the vehicle in the vehicle in a non-travelable mode where the vehicle is not allowed to travel, transitions the vehicle to a travelable mode where the vehicle is allowed to travel when the steering unlock recognition unit recognizes that the steering unlock state is attained by execution of the unlock processing, and prohibits transition to the travelable mode and maintains the vehicle in the non-travelable mode when the unlock processing is executed but the steering unlock recognition unit does not recognize that the steering unlock state is attained.

The vehicle control device in configuration 1 can transition the vehicle from the non-travelable mode to the travelable mode to prevent the vehicle from starting to travel in the situation where the steering unlock state is not recognized and the steering is insufficiently unlocked.

(Configuration 2) The vehicle control device according to configuration 1 includes a remote operation acceptance unit that accepts remote operation of the vehicle via communication with a communication terminal, in which the vehicle activation control unit executes remote activation processing for maintaining the non-travelable mode and putting a driving source included in the vehicle in an operating state when the remote operation acceptance unit accepts the activation operation of the vehicle in the non-travelable mode.

According to the vehicle control device in configuration 2, the driving source of the vehicle is put in an operating state by the remote operation, and the steering of the vehicle is maintained in a locked state and thereby vehicle theft can be prevented when the user performing the remote operation is away from the vehicle.

(Configuration 3) The vehicle control device according to configuration 2, in which the vehicle activation control unit gives a notification to urge an operation to start the travel of the vehicle by a notification unit included in the vehicle when the non-travelable mode is maintained and the driving source is in the operating state by the remote activation processing.

The vehicle control device in configuration 3 can urge a user, who rides in the vehicle with the driving source in the operating state in the non-travelable mode, to perform an operation to start the travel of the vehicle to put the vehicle in the travelable state.

(Configuration 4) The vehicle control device according to any one of configurations 1 to 3, including a travel end operation recognition unit that recognizes an operation to end the travel of the vehicle in the vehicle, in which the vehicle activation control unit maintains the vehicle in the travelable mode until the travel end operation recognition unit recognizes the operation to end the travel of the vehicle after the non-travelable mode is transitioned to the travelable mode.

The vehicle control device in configuration 4 can prevent the vehicle from being switched to the non-travelable mode during traveling.

(Configuration 5) The vehicle control device according to any one of configurations 1 to 4, in which the vehicle activation control unit gives a notification to urge an operation to unlock the steering by a notification unit included in the vehicle when the unlock processing is executed but the steering unlock recognition unit does not recognize that the steering unlock state is attained.

The vehicle control device in configuration 5 can urge a user of the vehicle to perform manual operation, or the like, to unlock the steering so as to achieve the steering unlocked, when the steering is not unlocked by the unlock processing.

(Configuration 6) The vehicle control device according to any one of configurations 1 to 5, including a user authentication unit that authenticates whether or not a registered specific user rides in the vehicle, in which the vehicle activation control unit executes processing to unlock the steering when the unlock processing is executed but the steering unlock recognition unit does not recognize that the steering unlock state is attained, and the user authentication unit authenticates that the specific user rides in the vehicle.

According to the vehicle control device in configuration 6, when it is determined that the vehicle is not likely to be stolen because it is authenticated that the specific user is riding in the vehicle, the processing to unlock the steering is executed. This eliminates the necessity of manual operation, or the like, of the specific user to unlock the steering, so that the burden of the specific user can be reduced.

(Configuration 7) A control method of a vehicle having a steering lock mechanism executed by a computer, the control method of the vehicle including: a steering lock control step of operating the steering lock mechanism to switch between a steering lock state where a steering included in the vehicle is not operable and a steering unlock state where the steering is operable; a steering unlock recognition step of recognizing the steering unlock state; a travel start operation recognition step of recognizing an operation to start travel of the vehicle in the vehicle; and a vehicle activation control step of executing unlock processing for operating the steering lock mechanism in the steering lock control step to attain the steering unlock state when the operation to start travel of the vehicle in the vehicle is recognized in the travel start operation recognition step in a non-travelable mode where the vehicle is not allowed to travel, transitioning the vehicle to a travelable mode where the vehicle is allowed to travel when it is recognized in the steering unlock recognition step that the steering unlock state is attained by execution of the unlock processing, and prohibiting transition to the travelable mode and maintaining the vehicle in the non-travelable mode when the unlock processing is executed but it is not recognized in the steering unlock recognition step that the steering unlock state is attained.

When the vehicle control method of configuration 7 is executed by a computer, the operational effects similar to those of the vehicle control device of configuration 1 can be obtained.

(Configuration 8) A non-transitory recording medium storing a program that allows a computer mounted on a vehicle having a steering lock mechanism to function as: a steering lock control unit that operates the steering lock mechanism to switch between a steering lock state where a steering included in the vehicle is not operable and a steering unlock state where the steering is operable; a steering unlock recognition unit that recognizes the steering unlock state is attained; a travel start operation recognition unit that recognizes an operation to start travel of the vehicle in the vehicle; and a vehicle activation control unit that executes unlock processing for operating the steering lock mechanism by the steering lock control unit to attain the steering unlock state when the travel start operation recognition unit recognizes the operation to start travel of the vehicle in the vehicle in a non-travelable mode where the vehicle is not allowed to travel, transitions the vehicle to a travelable mode where the vehicle is allowed to travel when the steering unlock recognition unit recognizes that the steering unlock state is attained by execution of the unlock processing, and prohibits transition to the travelable mode and maintains the vehicle in the non-travelable mode when the unlock processing is executed but the steering unlock recognition unit does not recognize that the steering unlock state is attained.

When the program of configuration 8 is executed by a computer, the operational effects similar to those of the vehicle control device of configuration 1 can be achieved.

### REFERENCE SIGNS LIST

1 . . . Vehicle, 10 . . . Vehicle control device, 20 . . . Processor, 21 . . . Remote operation acceptance unit, 22 . . . Steering lock control unit, 23 . . . Steering unlock recognition unit, 24 . . . Travel start operation recognition unit, 25 . . . Travel end operation recognition unit, 26 . . . Vehicle activation control unit, 27 . . . User authentication unit, 30 . . . Memory, 31 . . . Program, 40 . . . Communication unit, 41 . . . display unit, 42 . . . In-vehicle camera, 43 . . . SS switch, 50 . . . Driving source, 51 . . . Air conditioner, 60 . . . Steering, 61 . . . Steering sensor, 70 . . . ESL unit, 74 . . . Unlock sensor, 75 . . . Lock sensor, 90 . . . Communication terminal, U . . . User.

What is claimed is:

1. A vehicle control device mounted on a vehicle having a steering lock mechanism, the vehicle control device including:
a steering lock control unit that operates the steering lock mechanism to switch between a steering lock state where a steering included in the vehicle is not operable and a steering unlock state where the steering is operable;
a steering unlock recognition unit that recognizes the steering unlock state;
a travel start operation recognition unit that recognizes an operation to start travel of the vehicle in the vehicle; and
a vehicle activation control unit that executes unlock processing for operating the steering lock mechanism by the steering lock control unit to attain the steering unlock state when the travel start operation recognition unit recognizes an operation to start travel of the vehicle in the vehicle in a non-travelable mode where the vehicle is not allowed to travel, transitions the vehicle to a travelable mode where the vehicle is allowed to travel when the steering unlock recognition unit recognizes that the steering unlock state is attained by execution of the unlock processing, and prohibits transition to the travelable mode and maintains the vehicle in the non-travelable mode when the unlock processing is executed but the steering unlock recognition unit does not recognize that the steering unlock state is attained.

2. The vehicle control device according to claim 1, comprising a remote operation acceptance unit that accepts remote operation of the vehicle via communication with a communication terminal, wherein
the vehicle activation control unit executes remote activation processing for maintaining the non-travelable mode and putting a driving source included in the vehicle in an operating state when the remote operation acceptance unit accepts activation operation of the vehicle in the non-travelable mode.

3. The vehicle control device according to claim 2, wherein
the vehicle activation control unit gives a notification to urge an operation to start the travel of the vehicle by a notification unit included in the vehicle when the non-travelable mode is maintained and the driving source is in the operating state by the remote activation processing.

4. The vehicle control device according to claim 1, comprising a travel end operation recognition unit that recognizes an operation to end the travel of the vehicle in the vehicle, wherein
the vehicle activation control unit maintains the vehicle in the travelable mode until the travel end operation recognition unit recognizes the operation to end the travel of the vehicle after the non-travelable mode is transitioned to the travelable mode.

5. The vehicle control device according to claim 1, wherein
the vehicle activation control unit gives a notification to urge an operation to unlock the steering by a notification unit included in the vehicle when the unlock processing is executed but the steering unlock recognition unit does not recognize that the steering unlock state is attained.

6. The vehicle control device according to claim 1,
comprising a user authentication unit that authenticates whether or not a registered specific user rides in the vehicle, wherein
the vehicle activation control unit executes processing to unlock the steering when the unlock processing is executed but the steering unlock recognition unit does not recognize that the steering unlock state is attained, and the user authentication unit authenticates that the specific user rides in the vehicle.

7. A control method of a vehicle having a steering lock mechanism executed by a computer, the vehicle control method comprising:
a steering lock control step of operating the steering lock mechanism to switch between a steering lock state where a steering included in the vehicle is not operable and a steering unlock state where the steering is operable;
a steering unlock recognition step of recognizing the steering unlock state;
a travel start operation recognition step of recognizing an operation to start travel of the vehicle in the vehicle; and
a vehicle activation control step of executing unlock processing for operating the steering lock mechanism in the steering lock control step to attain the steering unlock state when the operation to start travel of the vehicle in the vehicle is recognized in the travel start operation recognition step in a non-travelable mode where the vehicle is not allowed to travel, transitioning the vehicle to a travelable mode where the vehicle is allowed to travel when it is recognized in the steering unlock recognition step that the steering unlock state is attained by execution of the unlock processing, and prohibiting transition to the travelable mode and maintaining the vehicle in the non-travelable mode when the unlock processing is executed but it is not recognized in the steering unlock recognition step that the steering unlock state is attained.

8. A non-transitory recording medium storing a program that allows a computer mounted on a vehicle having a steering lock mechanism to function as:
a steering lock control unit that operates the steering lock mechanism to switch between a steering lock state where a steering included in the vehicle is not operable and a steering unlock state where the steering is operable;
a steering unlock recognition unit that recognizes the steering unlock state;
a travel start operation recognition unit that recognizes an operation to start travel of the vehicle in the vehicle; and
a vehicle activation control unit that executes unlock processing for operating the steering lock mechanism by the steering lock control unit to attain the steering unlock state when the travel start operation recognition unit recognizes the operation to start travel of the vehicle in the vehicle in a non-travelable mode where the vehicle is not allowed to travel, transitions the vehicle to a travelable mode where the vehicle is allowed to travel when the steering unlock recognition unit recognizes that the steering unlock state is attained by execution of the unlock processing, and prohibits transition to the travelable mode and maintains the vehicle in the non-travelable mode when the unlock processing is executed but the steering unlock recognition unit does not recognize that the steering unlock state is attained.
